(19) United States
(12) Patent Application Publication
(10) Pub. No.: US 2023/0153505 A1
(43) Pub. Date: May 18, 2023

(54) MACHINE-LEARNING BASED ARCHITECTURAL DESIGN PLACEMENT FOR ELECTRONIC CIRCUITRY OF AN ELECTRONIC DEVICE

(71) Applicant: MediaTek Inc., Hsinchu (TW)

(72) Inventors: Wei-Hao CHANG, Hsinchu City (TW); Kai-En YANG, Hsinchu City (TW); Kao-I CHAO, Hsinchu City (TW); Yu-Hsun CHEN, Hsinchu City (TW); Cheng-Feng CHIANG, Hsinchu City (TW); Yen Min TSAI, Singapore (SG); Sau Loong LOW, Singapore (SG); Chia-Shun YEH, Hsinchu City (TW); Bun Suan HENG, Singapore (SG); Chia-Yu TSAI, Hsinchu City (TW); Chin-Tang LAI, Hsinchu City (TW); Hung-Hao SHEN, Hsinchu City (TW)

(73) Assignee: MediaTek Inc., Hsinchu (TW)

(21) Appl. No.: 17/903,873

(22) Filed: Sep. 6, 2022

Related U.S. Application Data
(60) Provisional application No. 63/279,205, filed on Nov. 15, 2021.

(51) Int. Cl. G06F 30/392; G06F 30/398

(52) U.S. Cl. CPC G06F 30/392; G06F 30/398

(57) ABSTRACT

Electronic design automation (EDA) of the present disclosure logically places components of the electronic circuitry onto an electronic design real estate to determine an architectural design placement for the electronic circuitry. The EDA evaluates a metaheuristic algorithm starting with an initial placement of components of the electronic circuitry onto the electronic design real estate to provide multiple possible placements for placing these components of the electronic circuitry onto the electronic design real estate. The EDA utilizes the multiple possible placements of the metaheuristic algorithm to train one or more probabilistic functions of a model-based reinforcement learning (RL) algorithm. The EDA evaluates the model-based RL algorithm utilizing the one or more probabilistic functions to determine the architectural design placement. The EDA can further iteratively enhance the architectural design placement by re-evaluating the metaheuristic algorithm starting from the architectural design placement as the initial placement of components, re-training the one or more probabilistic functions, and re-evaluating the model-based RL algorithm utilizing the one or more probabilistic functions.

### CROSS-REFERENCE TO RELATED APPLICATIONS

The present application claims the benefit of U.S. Provisional Patent Appl. No. 63/279,205, filed Nov. 15, 2021, which is incorporated herein by reference in its entirety.

### BACKGROUND

The process of placing analog circuit on an integrated circuit (IC) device has been a longstanding problem ascribing to ever-increasing design constraints and intricate physical effects. The process is labor-intensive and time-consuming, which is only becoming worse as components on IC devices become smaller over time. Electronic design automation (EDA), also referred to as electronic computer-aided design (ECAD), can be utilized to minimize the difficulty in designing electronic devices. Many electronic design software tools are available to the electronic designers for designing, simulation, analyzing, and verifying the integrated circuits and/or printed circuit boards for the electronic circuitry. EDA represents one category of software tools available to these designers for developing integrated circuits and/or printed circuit boards for the electronic circuitry. The electronic designers use these software tools, including EDA, to place electrical, mechanical, and/or electro-mechanical components of the electronic circuitry within a dedicated space of the integrated circuits and/or printed circuit boards, also referred to as an electronic design real estate, to determine an architectural design placement for the components. Often times, however, the electronic design software tools require the electronic designers to manually draw these components of the electronic circuitry onto the electronic design real estate. This manual drawing is especially prevalent in the design of analog integrated circuits and/or analog printed circuit boards and is often highly error prone and exceedingly time-consuming.

### BRIEF DESCRIPTION OF THE DRAWINGS

The present disclosure is described with reference to the accompanying drawings. In the drawings, like reference numbers indicate identical or functionally similar elements. Additionally, the left most digit(s) of a reference number identifies the drawing in which the reference number first appears. In the accompanying drawings:

FIG. 1 illustrates a block diagram of an electronic design platform according to some embodiments of the present disclosure;

FIG. 2 graphically illustrates a training of a policy function of a model-based reinforcement learning (RL) algorithm that can be performed by the design environment according to some embodiments of the present disclosure;

FIG. 3 graphically illustrates a training of a value function of a model-based reinforcement learning (RL) algorithm that can be performed by the design environment according to some embodiments of the present disclosure;

FIG. 4 illustrates a flowchart of an operation of the electronic design platform in placing analog modules onto placement sites according to an embodiment of the present disclosure;

FIG. 5 graphically illustrates an operation of the electronic design platform in placing analog modules onto placement sites according to an embodiment of the present disclosure;

FIG. 6 graphically illustrates a simplified block diagram of a computer network for executing the electronic design platform according to some embodiments of the present disclosure; and

FIG. 7 graphically illustrates a simplified block diagram of a computer system for executing the electronic design platform according to some embodiments of the present disclosure.

The present disclosure will now be described with reference to the accompanying drawings.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition does not in itself dictate a relationship between the various embodiments and/or configurations discussed.

### Overview

Electronic design automation (EDA) of the present disclosure logically places components of the electronic circuitry onto an electronic design real estate to determine an architectural design placement for the electronic circuitry. The EDA evaluates a metaheuristic algorithm starting with an initial placement of components of the electronic circuitry onto the electronic design real estate to provide multiple possible placements for placing these components of the electronic circuitry onto the electronic design real estate. The EDA utilizes the multiple possible placements of the metaheuristic algorithm to train one or more probabilistic functions of a model-based reinforcement learning (RL) algorithm. The EDA evaluates the model-based RL algorithm utilizing the one or more probabilistic functions to determine the architectural design placement. The EDA can further iteratively enhance the architectural design placement by re-evaluating the metaheuristic algorithm starting from the architectural design placement as the initial placement of components, re-training the one or more probabilistic functions, and re-evaluating the model-based RL algorithm utilizing the one or more probabilistic functions.

Electronic Design Platform

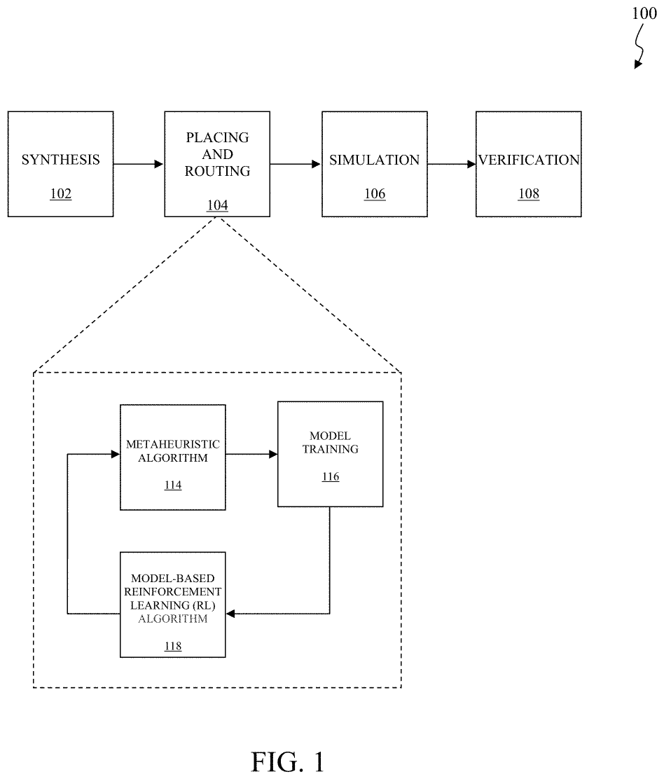

FIG. 1 illustrates a block diagram of an exemplary electronic design platform according to some embodiments of the present disclosure. As illustrated in FIG. 1, an electronic design platform 100 represents an electronic design flow including one or more electronic design software tools, that when executed by one or more computing devices, processors, controllers, or other electrical, mechanical, and/or electro-mechanical devices that will be apparent to those skilled in the relevant art(s) without departing from the spirit and the scope of the present disclosure, can design, simulate, analyze, and/or verify an architectural design layout of electronic circuitry for an electronic device. As to be described in further detail below, the electronic design platform 100 logically places electrical, mechanical, and/or electro-mechanical components, generically referred to herein as “components,” of the electronic circuitry onto an electronic design real estate to determine an architectural design placement for the electronic circuitry. The electronic design platform 100 evaluates a metaheuristic algorithm starting from an initial placement of the components of the electronic circuitry onto the electronic design real estate to provide multiple possible solutions for placing the components of the electronic circuitry onto the electronic design real estate. The electronic design platform 100 utilizes the multiple possible solutions of the metaheuristic algorithm to train one or more probabilistic functions of a model-based reinforcement learning (RL) algorithm. The electronic design platform 100 evaluates the model-based RL algorithm utilizing the one or more probabilistic functions to determine the architectural design layout. In some embodiments, the electronic design platform 100 can further iteratively enhance the architectural design placement by re-evaluating the metaheuristic algorithm starting from the architectural design placement as the initial placement of components, re-training the one or more probabilistic functions, and re-evaluating the model-based RL algorithm utilizing the one or more probabilistic functions.

In the embodiment illustrated in FIG. 1, the electronic design platform 100 includes a synthesis tool 102, a placing and routing tool 104, a simulation tool 106, a verification tool 108, and/or any combination thereof. These tools, which are to be described in further detail below, represent one or more electronic design software tools, that when executed by one or more computing devices, processors, controllers, or other electrical, mechanical, and/or electro-mechanical devices that will be apparent to those skilled in the relevant art(s), can design, simulate, analyze, and/or verify an architectural design layout. Those skilled in the relevant art(s) will recognize that embodiments of the disclosure described herein may be implemented in hardware, firmware, software (executing on a process), or any combination thereof without departing from the present disclosure. Alternatively, or in addition to, those skilled in the relevant art(s) will recognize that embodiments of the disclosure described herein may also be implemented as instructions stored on a machine-readable medium, which may be read and executed by one or more processors without departing from the present disclosure. A machine-readable medium may include any mechanism for storing in a form readable by a machine, such as a computing device to provide an example. For example, a machine-readable medium may include read only memory (ROM); random access memory (RAM); magnetic disk storage media; optical storage media; flash memory devices; and others. Further, those skilled in the relevant art(s) will recognize that firmware, software, routines, instructions may be described herein as performing certain actions without departing from the present disclosure. However, it should be appreciated that such descriptions are merely for convenience and that such actions in fact result from computing devices, processors, controllers, or other devices executing the firmware, software, routines, instructions, etc.

The synthesis tool 102 translates one or more characteristics, parameters, or attributes of the electronic circuitry into one or more operations, such as one or more logic operations, one or more arithmetic operations, one or more control operations, and/or any other suitable operations that will be apparent to those skilled in the relevant art(s) without departing from the present disclosure. In some embodiments, the one or more operations can be expressed using one or more high-level software level descriptions. In an embodiment, the one or more high-level software level descriptions can represent a textual representation of the electronic circuitry, such as a netlist; a high-level software model of the electronic circuitry using a high-level software language, for example C, System C, C++, LabVIEW, and/or MATLAB, a general purpose system design language, such as like SysML, SMDL and/or SSDL, or a high-level software format, such as Common Power Format (CPF), Unified Power Formant (UPF); or an image-based representation of the electronic circuitry, such as a computer-aided design (CAD) model to provide an example. The synthesis tool 102 can utilize a simulation algorithm to simulate the one or more logic operations in accordance with the one or more characteristics, parameters, or attributes for the electronic circuitry as outlined, for example, in an electronic design specification.

The placing and routing tool 104 defines the one or more operations from the synthesis tool 102 in terms of geometric shapes which correspond to diffusion layers, polysilicon layers, and/or metal layers of an integrated circuit as well as interconnections between these layers to provide the architectural design layout. The placing and routing tool 104 logically places components of the electronic circuitry as described by the one or more high-level software level descriptions of the electronic circuitry onto an electronic design real estate to determine architectural design placement for the electronic circuitry. In some embodiments, the components of the electronic circuitry can include analog components of the electronic circuitry such as metal oxide silicon (MOS) transistors, resistors, inductors, and/or capacitors to provide some examples.

As illustrated in FIG. 1, the placing and routing tool 104 includes a metaheuristic algorithm tool 114, a model training tool 116, and a model-based RL algorithm tool 118. The metaheuristic algorithm tool 114, the model training tool 116, and the model-based RL algorithm tool 118, when executed by one or more computing devices, processors, controllers, or other electrical, mechanical, and/or electro-mechanical devices, can logically place the components of the electronic circuitry onto the electronic design real estate to provide the architectural design placement for the electronic circuitry. In the embodiment illustrated in FIG. 1, components of the electronic circuitry can be configured and arranged into modules. Generally, the modules can include one or components of the electronic circuitry and their interconnect structures that functionally cooperate with one another to provide one or more functions of the electronic device. The modules also have pins that allow these modules to connect to other modules. In some embodiments, the modules can occupy arbitrary shapes, for example, rectangular shapes, on the electronic design real estate. In these embodiments, one or more of the modules can have different rectangular shapes from one another. As to be described in further detail below, the metaheuristic algorithm tool 114, the model training tool 116, and the model-based RL algorithm tool 118 functionally cooperate with each other to optimally place the modules onto the electronic design real estate.

The metaheuristic algorithm tool 114 evaluates a metaheuristic algorithm, such as an iterated local search algorithm, a genetic algorithm, simulated annealing, an ant colony optimization, a tabu search and/or a particle swarm optimization to provide some examples, to place the modules onto the electronic design real estate to provide multiple placements of the modules onto the placement sites. Generally, the metaheuristic algorithm tool 114 can evaluate the metaheuristic algorithm to determine a placement of the modules onto the electronic design real estate, X̅=(X₁, X₂, . . . X_{N}), that optimizes, for example, minimizes, one or more energy functions ƒ(X̅). The one or more energy functions ƒ(X̅) can be related to a placement area, a wirelength, a link loss, a normalized dead space, a normalized half-perimeter wirelength (HPWL), a routability, a power consumption, a thermal property, a design rule violation, and/or a constraint based on an electronic design automation (EDA) simulation result to provide some examples.

The electronic design real estate can include a series of rows that intersect with a series of columns to form placement sites for placing the modules. Generally, these placement sites represent basic units of integrated circuit design for placing the modules. As part of the metaheuristic algorithm, the metaheuristic algorithm tool 114 begins with an initial placement of the modules onto the placement sites, also referred to as an initial solution. In some embodiments, the initial solution can be a random initial placement of the modules onto the placement sites and/or can be the architectural design placement as determined by the model-based RL algorithm tool 118 as to be described in further detail below. In some embodiments, the metaheuristic algorithm tool 114 can evaluate the metaheuristic algorithm starting from the random initial placement of the modules onto the placement sites and can evaluate the metaheuristic algorithm starting from the architectural design placement as determined by the model-based RL algorithm tool 118 on subsequent evaluations. In some embodiments, the random initial placement of the modules can satisfy one or more electronic design constraints. In these embodiments, the one or more electronic design constraints can require modules in the same row or column of placement sites to be of the same type, modules with no shared pins to be separated by a spacing, and/or adjacent rows or columns of placement sites to have at least one shared circuit node from among the one or more high-level software level descriptions. However, other constraints are possible as will be apparent to those skilled in the relevant art(s) without departing from the present disclosure. The metaheuristic algorithm tool 114 thereafter moves one or more of the modules from their placement in an existing placement of the modules, also referred to as an existing solution, onto the placement sites to provide a new placement of the modules, also referred to as a new solution. In some embodiments, the moves can include swapping position of the one or more modules with adjacent placement sites, reshaping the one or more modules, inserting one or more rows or columns of placement sites between other rows or columns of placement sites, and/or switching configuration of the one or more modules, for example, switching to symmetric devices to provide some examples. The moves can include legal moves that satisfy the one or more electronic design constraints as described above and/or illegal moves that do not satisfy the one or more electronic design constraints.

After moving the one or more of the modules, the metaheuristic algorithm tool 114 evaluates the one or more energy functions ƒ(X̅) in accordance with the new solution to determine whether to accept the new solution as a starting point for further moves or to reject the new solution and revert to the existing solution. In some embodiments, the metaheuristic algorithm tool 114 accepts the new solution when the new solution has a lower energy than the existing solution. In some embodiments, the metaheuristic algorithm tool 114 can accept the new solution when the new solution has a higher energy than the existing solution based upon a probability distribution function, for example, a Boltzmann distribution. In these embodiments, the probability of accepting the new solution when the new solution has the higher energy decreases as the metaheuristic algorithm tool 114 evaluates the metaheuristic algorithm, for example, over time.

In the embodiment illustrated in FIG. 1, the metaheuristic algorithm tool 114 continues to move one or more of the modules from existing solutions to provide new solutions until reaching a stopping criterion. In some embodiments, the stopping criterion can occur upon completion of a predetermined number of moves, when the change in the energy across multiple solutions, for example, three successive solutions, is sufficiently small, for example, less than one (1) percent, and/or when the probability of accepting the new solution when the new solution has the higher energy is less than a lower bound to provide some examples. Upon reaching the stopping criterion, the metaheuristic algorithm tool 114 provides the current solution as a possible placement of the modules onto the placement sites, also referred to as a possible solution. Preferably, the metaheuristic algorithm tool 114 can evaluate the metaheuristic algorithm over multiple iterations to provide multiple possible placements of the modules onto the placement sites, also referred to as multiple possible solutions. In some embodiments, some of these multiple possible solutions can be different placements of the modules onto the placement sites when compared to one another even if the same initial solution is used to evaluate the metaheuristic algorithm.

The model training tool 116 utilizes the multiple possible solutions of the metaheuristic algorithm provided by the metaheuristic algorithm tool 114 to train one or more probabilistic functions of the model-based RL algorithm, such as an AlphaGo RL algorithm, an AlphaZero RL algorithm, or a MuZero RL algorithm to provide some examples. In the embodiment illustrated in FIG. 1, the model training tool 116 decomposes the multiple possible solutions of the metaheuristic algorithm provided by the metaheuristic algorithm tool 114 into multiple trajectories of placement data that can be used to train the one or more probabilistic functions. The multiple trajectories of the placement data include sequential representations of the moves, or set of actions A, performed by the metaheuristic algorithm tool 114 for each of the existing solutions, or set of states S, to provide the multiple possible solutions as described above. In the embodiment illustrated in FIG. 1, each state s from among the set of states S represents a different placement of the modules onto the placement sites. And each action a from among the set of actions A represents a different move that can be performed by the metaheuristic algorithm tool 114 over the set of states S. In some embodiments, the multiple trajectories of the placement data can include multiple Markov decision process (MDP) trajectories. In these embodiments, a trajectory of the placement data τᵢ from among the multiple trajectories of placement data can be mathematically expressed as:

τᵢ=(s₀,a₀,s₁,a₁. . . s_{T},a_{U}), (1)

wherein (s₀, s₁, . . . s_{T}) represents a sequence of states from among the set of states S and (a₀, a₁ . . . a_{U}) represents a sequence of actions performed by the metaheuristic algorithm tool 114 from among the set of actions A over the states (s₀, s₁, . . . s_{T}). In some embodiments, the multiple trajectories of placement data can be associated with the energies, or reward scores, that were determined by the metaheuristic algorithm tool 114 from the one or more energy functions ƒ(X̅) as described above over the set of states S, for example, the states (s₀, s₁, . . . s_{T}). In these embodiments, the multiple trajectories of placement data can be associated with the final energies, or final reward scores, that were determined by the metaheuristic algorithm tool 114 by evaluating the one or more energy functions ƒ(X̅) over a final state from among the set of states S, for example, the state s_{T}.

The one or more probabilistic functions can include a policy function and/or a value function to provide some examples. The policy function mathematically describes the decision-making process of the model-based RL algorithm tool 118 as to be described in further detail below. In some embodiments, the policy function can be implemented using a stochastic policy, such as a categorical policy for discrete action spaces to provide an example, that outlines probability distributions for performing each action a from among the set of actions A over the set of states S. In some embodiments, the stochastic policy function can be denoted as:

π(a,s)=Pr(a=aₜ|s=sₜ), (2)

wherein the policy function π(a, s) provides the probability of performing an action a from among the set of actions A over a state s from among the set of states S. As to be described in further detail below, the model training tool 116 can estimate the probability of performing each action a from among the set of actions A over the set of states S based on the multiple trajectories of placement data. In some embodiments, the model training tool 116 can estimate a probability density function for a state sᵢ from among the set of states S based upon the actions (a₀, a₁ . . . a_{U}) performed by the multiple trajectories of placement data while in the state sᵢ.

The value function mathematically determines the value, or worth, of the model-based RL algorithm tool 118 being in a specific state s from among the set of states S. In some embodiments, the value function can include the on-policy value function, the on-policy action-value function, the optimal value function, and/or the optimal action-value function to provide some examples. In the embodiment illustrated in FIG. 1, the value function can be defined in terms of future rewards that can be expected, namely, in terms of expected return. Generally, the value function for a specific state s from among the set of states S can be mathematically approximated as:

V(s)←V(s)+a(V(s′)−V(s)), (3)

wherein V(s) represents a value of being in the specific state s and V(s′) represents a value of being in a next state s′ from among the set of states S, and a represents the learning rate.

As described above, the multiple trajectories of placement data can be associated with the energies, or reward scores, that were determined by the metaheuristic algorithm tool 114 from the one or more energy functions ƒ(X̅) as described above over the set of states S, for example, the states (s₀, s₁, . . . s_{T}). The model training tool 116 can estimate the rewards that can be expected for performing an action a from among the set of actions A in each state s from among the set of states S. In some embodiments, the model training tool 116 can estimate the rewards based upon the final energies, or the final reward scores, that were determined by the metaheuristic algorithm tool 114 by evaluating the one or more energy functions ƒ(X̅) over a final state from among the set of states S, for example, the state s_{T}. And from Equation (3) above, the model training tool 116 can inspect the states (s₀, s₁, . . . s_{T}) of the multiple trajectories of placement data backwards and can thereafter estimate the energies, or the reward scores, over the set of states S starting from the final energies, or the final reward scores, using, for example, a backtracking algorithm.

After estimating the energies, or the reward scores, over the set of states S, the model training tool 116 can estimate the value function. Generally, the value function, for Markov decision process (MDP) trajectories, can be expressed as:

V(s)=E_{π}{Rₜ|sₜ=s}, (4)

wherein E_{π}{ } represents the expected value given that the model-based RL algorithm tool 118 follows a policy function π as described above and Rₜ represents the rewards that can be expected for being in a specific state s from among the set of states S. As such, the model training tool 116 can estimate the value function as being approximately equivalent to a sum of products of the energies, or the reward scores, for the actions (a₀, a₁ . . . a_{U}) that were performed while in the states (s₀, s₁, . . . s_{T}) and the probabilities of selecting the actions (a₀, a₁ . . . a_{U}) while in the states (s₀, s₁, . . . s_{T}) as outlined by the policy function as described above.

The model-based RL algorithm tool 118 can evaluate the model-based RL algorithm, such as an AlphaGo RL algorithm, an AlphaZero RL algorithm, or a MuZero RL algorithm to provide some examples, utilizing the one or more probabilistic functions provided by the model training tool 116 to determine the placement of the modules onto the placement sites to provide the architectural design placement. In some embodiments, the model-based RL algorithm tool 118 can provide the architectural design placement to the metaheuristic algorithm tool 114 as the initial solution for the metaheuristic algorithm as described above. In some embodiments, the metaheuristic algorithm tool 114, the model training tool 116, and the model-based RL algorithm tool 118 can further iteratively enhance the architectural design placement by re-evaluating the metaheuristic algorithm starting from the architectural design placement as the initial placement of components, re-training the one or more probabilistic functions, and re-evaluating the model-based RL algorithm utilizing the one or more probabilistic functions. In the embodiment illustrated in FIG. 1, the model-based RL algorithm tool 118 can evaluate the model-based RL algorithm using a discrete-time stochastic control process, such as a Markov decision process (MDP) to provide an example, to maximize the expected cumulative reward. Generally, the MDP can be modeled using the set of states S, the set of actions A, the policy function provided by the model training tool 116, and the value function provided by the model training tool 116. In some embodiments, the set of states S can represent a slicing tree constructed by a Polish expression having horizontal cuts and/or vertical cuts or a slicing tree constructed by a simplified Polish expression having horizontal cuts. At each time t, the model-based RL algorithm tool 118 identifies a specific state s from among the set of states S and a reward that is associated with the model-based RL algorithm tool 118 being in the specific state s. In some embodiments, the reward can be zero (0) for non-terminating states from among the set of states S and the energies, or reward scores, that can be determined by evaluating the one or more energy functions ƒ(X̅) as described above for terminating states from among the set of states S. The model-based RL algorithm tool 118 then identifies the best action a from among the set of actions A to be performed while in the specific state s. In some embodiments, the model-based RL algorithm tool 118 can implement an iterative tree search procedure, such as a general-purpose Monte Carlo tree search (MCTS) algorithm to provide an example, to identify the best action a from among the set of actions A to be performed while in the specific state s in accordance with the policy function and/or the value function. In some embodiments, the general-purpose MCTS algorithm can utilize the policy function provided by the model training tool 116 and the value function provided by the model training tool 116 to determine a search tree to identify the best action a from among the set of actions A to be performed while in the specific state s. In these embodiments, the model-based RL algorithm can train a dynamic function, a reward function, and/or the policy function provided by the model training tool 116 to generate one or more steps of lookahead for downstream predictions for the general-purpose MCTS algorithm. The best action a can include legal actions that satisfy one or more electronic design constraints and/or illegal actions that do not satisfy the one or more electronic design constraints. In these embodiments, the one or more electronic design constraints can require modules in the same row or column of placement sites to be of the same type, modules with no shared pins to be separated by a spacing, and/or adjacent rows or columns of placement sites to have at least one shared circuit node from among the one or more high-level software level descriptions. After identifying the best action a, the model-based RL algorithm tool 118 proceeds to a next state s′ from among the set of states S.

After executing the metaheuristic algorithm tool 114, the model training tool 116, and the model-based RL algorithm tool 118, the placing and routing tool 104 assigns geometric shapes to the various components of the electronic circuitry, assigns locations for the geometric shapes within the electronic design real estate, and/or routes interconnections between the geometric shapes to provide the architectural design layout. In an embodiment, the placing and routing tool 104 utilizes a textual or an image-based netlist describing the electronic circuitry, a technology library for manufacturing the electronic device, a semiconductor foundry for manufacturing the electronic device, and/or a semiconductor technology node for manufacturing the electronic device to place the various components, to assign the geometric shapes to the various components of the electronic circuitry, to assign locations for the geometric shapes within the electronic design real estate, and/or to route the interconnections between the geometric shapes.

The simulation tool 106 simulates the geometric shapes, the locations of the geometric shapes, and/or the interconnections between the geometric shapes as described by the architectural design layout to replicate one or more characteristics, parameters, or attributes of the geometric shapes, the locations of the geometric shapes, and/or the interconnections between the geometric shapes. In an embodiment, the simulation tool 106 can provide a static timing analysis (STA), a voltage drop analysis, also referred to an IREM analysis, a Clock Domain Crossing Verification (CDC check), a formal verification, also referred to as model checking, equivalence checking, or any other suitable analysis that will be apparent to those skilled in the relevant art(s) without departing from the present disclosure. In another embodiment, the simulation tool 106 can perform an alternating current (AC) analysis, such as a linear small-signal frequency domain analysis, and/or a direct current (DC) analysis, such as a nonlinear quiescent point calculation or a sequence of nonlinear operating points calculated while sweeping a voltage, a current, and/or a parameter to perform the STA, the IREM analysis, or the other suitable analysis.

The verification tool 108 validates the one or more characteristics, parameters, or attributes of the geometric shapes, the locations of the geometric shapes, and/or the interconnections between the geometric shapes as replicated by the simulation tool 106 satisfy the electronic design specification. The verification tool 108 can also perform a physical verification, also referred to as a design rule check (DRC), to check whether the geometric shapes, the locations of the geometric shapes, and/or the interconnections between the geometric shapes assigned by the placing and routing tool 104 satisfies a series of recommended parameters, referred to as design rules, as defined by a semiconductor foundry and/or semiconductor technology node for manufacturing the electronic device.

Training of a Policy Function that can be Performed by the Electronic Design Platform

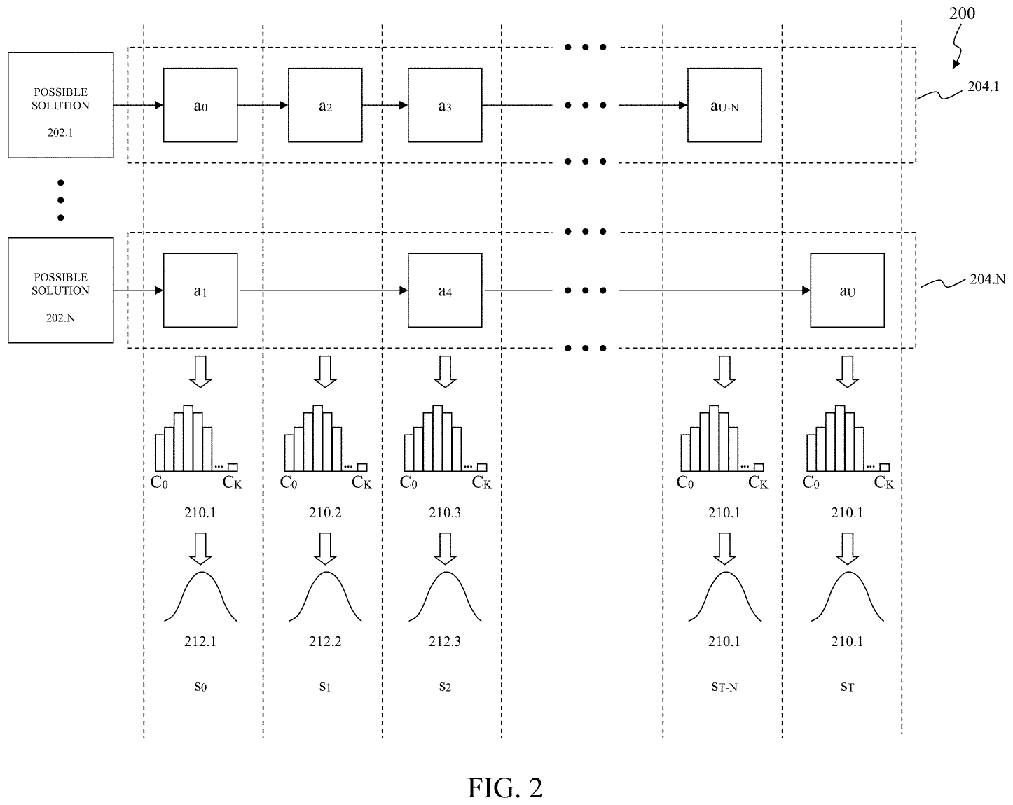

FIG. 2 graphically illustrates a training of a policy function of a model-based reinforcement learning (RL) algorithm that can be performed by the design environment according to some embodiments of the present disclosure. In the embodiment illustrated in FIG. 2, a model training tool 200, when executed by one or more computing devices, processors, controllers, or other electrical, mechanical, and/or electro-mechanical devices, can train a policy function of a model-based reinforcement learning (RL) algorithm, such as an AlphaGo RL algorithm, an AlphaZero RL algorithm, or a MuZero RL algorithm. The model training tool 200 can represent an embodiment of the model training tool 116 as described above in FIG. 1.

As illustrated in FIG. 2, the model training tool 200 can obtain possible solutions 202.1 through 202.N for placing components of the electronic circuitry onto an electronic design real estate. In some embodiments, the possible solutions 202.1 through 202.N can be provided by evaluating the metaheuristic algorithm as described above to place the components of the electronic circuitry onto the electronic design real estate. After obtaining the possible solutions 202.1 through 202.N, the model training tool 200 decomposes the possible solutions 202.1 through 202.N into trajectories of placement data 204.1 through 204.N that can be used to train a policy function of a model-based RL algorithm, such as an AlphaGo RL algorithm, an AlphaZero RL algorithm, or a MuZero RL algorithm to provide some examples.

The model training tool 200 decomposes the possible solutions 202.1 through 202.N into their corresponding states (s₀, s₁, . . . s_{T}) from among the set of states S as described above in FIG. 1 and their corresponding actions (a₀, a₁ . . . a_{U}) from among the set of actions A that were performed over their corresponding states (s₀, s₁, . . . s_{T}) to provide the trajectories of placement data 204.1 through 204.N. As illustrated in FIG. 2, the model training tool 200 decomposes the possible solution 202.1 into the state s₀ and the action a₀ that was performed by evaluating the metaheuristic algorithm to enter the state s₁, the action a₂ that was performed by evaluating the metaheuristic algorithm in the state s₁ to enter the state s₂, the action a₃ that was performed by evaluating the metaheuristic algorithm in the state s₂ to enter the state s_{T-N}, and the action a_{T-N} that was performed by evaluating the metaheuristic algorithm in the state s_{T-N}. Similarly, the model training tool 200 decomposes the possible solution 202.N into the state s₀ and the action a₁ that was performed by evaluating the metaheuristic algorithm to enter the state s₂, the action a₄ that was performed by evaluating the metaheuristic algorithm in the state s₂ to enter the state s_{T}, and the action a_{T} that was performed by evaluating the metaheuristic algorithm in the state s_{T}. However, it should be noted that the states (s₀, s₁, . . . s_{T}) and the actions (a₀, a₁ . . . a_{U}) as illustrated in FIG. 2 are for purposes only and are not limiting. Those skilled in the relevant art(s) will recognize that different states and/or actions are possible without departing from the present disclosure.

Once the possible solutions 202.1 through 202.N have been decomposed into the trajectories of placement data 204.1 through 204.N, the model training tool 200 estimates probability density functions 212.1 through 212.K that outline probability distributions for performing each of the actions (a₀, a₁ . . . a_{U}) while in the states (s₀, s₁, . . . s_{T}). As illustrated in FIG. 2, the model training tool 200 can transform the actions (a₀, a₁ . . . a_{U}) performed over the states (s₀, s₁, . . . s_{T}) into state histograms 210.1 through 210.K. The model training tool 200 can transform the actions (a₀, a₁ . . . a_{U}) performed over the states (s₀, s₁, . . . s_{T}) into the state histograms 210.1 through 210.K using any suitable well-known statistical technique that will be apparent to those skilled in the relevant art(s) without departing from the present disclosure. In the embodiment illustrated in FIG. 2, the state histograms 210.1 through 210.K can include multiple containers C₀ through C_{K} with each of the multiple containers C₀ through C_{K} corresponding to one of the actions a₀, a₁, . . . a_{K}. Generally, this suitable well-known statistical technique can accumulate the actions (a₀, a₁ . . . a_{U}) performed over the states (s₀, s₁, . . . s_{T}) into the multiple containers C₀ through C_{K} to provide the state histograms 210.1 through 210X. For example, the statistical technique can increment a container C₀ from among the multiple containers C₀ through C_{K} corresponding to the action a₀ by one (1) to accumulate the action a₀ for the state s₀ of the trajectory of placement data 204.1 and a container Ci from among the multiple containers C₀ through C_{K} corresponding to the action a₁ by one (1) to accumulate the action a₁ for the state s₀ of the trajectory of placement data 204.N to provide the state histogram 210.1.

After transforming the actions (a₀, a₁ . . . a_{U}) performed over the states (s₀, s₁, . . . s_{T}) into the state histograms 210.1 through 210.K, the model training tool 200 estimates probability density functions 212.1 through 212.K from the state histograms 210.1 through 210.K for each of states so through SK. The model training tool 200 can estimate the probability density functions 212.1 through 212.K from the state histograms 210.1 through 210.K using a parametric density estimation technique, however, more complicated non-parametric density estimation techniques are possible for estimating the probability density functions 212.1 through 212.K as will be recognized by those skilled in the relevant art(s) without departing from the present disclosure. As part of the parametric density estimation technique, the model training tool 200 selects a well-known probability density function, such as the normal distribution, the logistic distribution, the Student's t-distribution, the log-normal distribution, the log-logistic distribution, the Gumbel distribution, the exponential distribution, the Pareto distribution, the Weibull distribution, the Burr distribution, the Fréchet distribution, the square-normal distribution, the inverted Gumbel distribution, the Dagum distribution, or the Gompertz distribution to provide some examples, and then determines one or more parameters, for example, an expectation, a mean, a standard deviation, and/or a variance, of this selected probability density function from the state histograms 210.1 through 210.K to estimate the probability density functions 212.1 through 212.K. As part of the non-parametric density estimation technique, the model training tool 200 can perform a density estimation technique, such as kernel density estimation (KDE) to provide an example, to fit one or more statistical models to the state histograms 210.1 through 210.K to estimate the probability density functions 212.1 through 212.K.

Training of a Value Function that can be Performed by the Electronic Design Platform

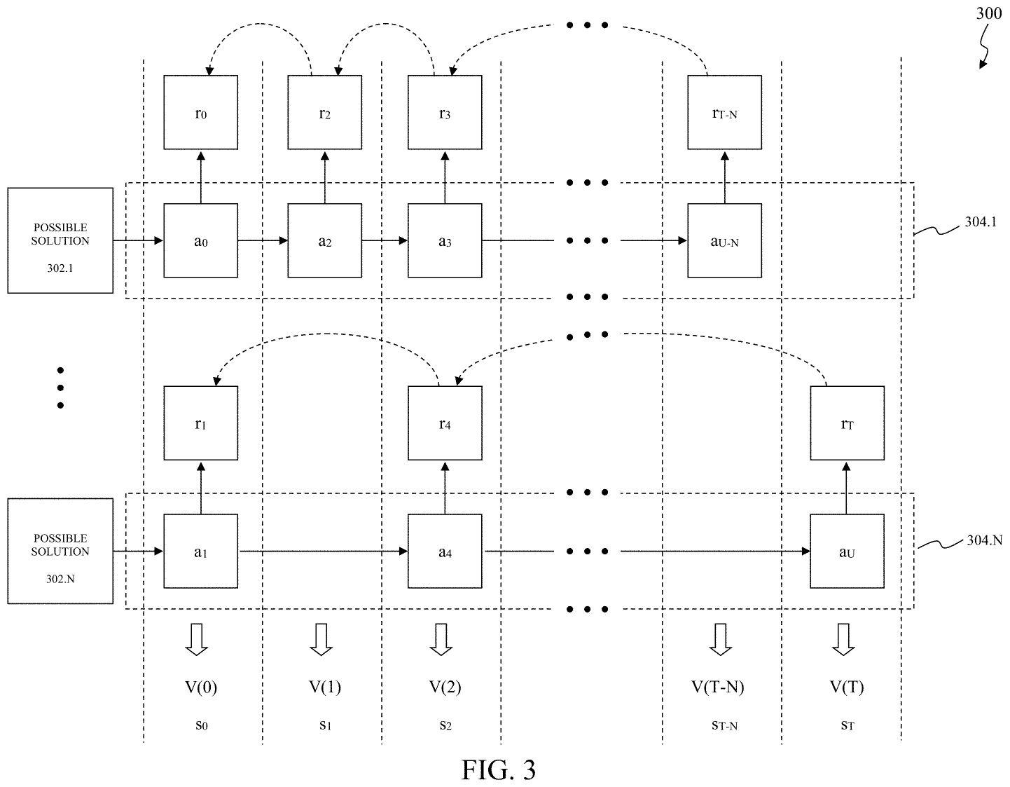

FIG. 3 graphically illustrates a training of a value function of a model-based reinforcement learning (RL) algorithm that can be performed by the design environment according to some embodiments of the present disclosure. In the embodiment illustrated in FIG. 3, a model training tool 300, when executed by one or more computing devices, processors, controllers, or other electrical, mechanical, and/or electro-mechanical devices that will be apparent to those skilled in the relevant art(s), can train a value function of a model-based RL reinforcement learning (RL) algorithm, such as an AlphaGo RL algorithm, an AlphaZero RL algorithm, or a MuZero RL algorithm to provide some examples. The model training tool 300 can represent an embodiment of the model training tool 116 as described above in FIG. 1.

As illustrated in FIG. 3, the model training tool 300 can obtain possible solutions 302.1 through 302.N for placing components of the electronic circuitry onto an electronic design real estate. In some embodiments, the possible solutions 302.1 through 302.N can be provided by evaluating the metaheuristic algorithm as described above to place the components of the electronic circuitry onto the electronic design real estate. After obtaining the possible solutions 302.1 through 302.N, the model training tool 300 decomposes the possible solutions 302.1 through 302.N into trajectories of placement data 304.1 through 304.N that can be used to train a policy function of a model-based RL algorithm, such as an AlphaGo RL algorithm, an AlphaZero RL algorithm, or a MuZero RL algorithm to provide some examples.

The model training tool 300 decomposes the possible solutions 302.1 through 302.N into their corresponding states (s₀, s₁, . . . s_{T}) from among the set of states S as described above in FIG. 1 and their corresponding actions (a₀, a₁ . . . a_{U}) from among the set of actions A that were performed over their corresponding states (s₀, s₁, . . . s_{T}) to provide the trajectories of placement data 304.1 through 304.N. As illustrated in FIG. 3, the model training tool 300 decomposes the possible solution 302.1 into the state s₀ and the action a₀ that was performed by evaluating the metaheuristic algorithm to enter the state s₁, the action a₂ that was performed by evaluating the metaheuristic algorithm in the state s₁ to enter the state s₂, the action a₃ that was performed by evaluating the metaheuristic algorithm in the state Ω to enter the state s_{T-N}, and the action a_{T-N} that was performed by evaluating the metaheuristic algorithm in the state s_{T-N}. Similarly, the model training tool 300 decomposes the possible solution 302.N into the state s₀ and the action a₁ that was performed by evaluating the metaheuristic algorithm to enter the state s₂, the action a₄ that was performed by evaluating the metaheuristic algorithm in the state Ω to enter the state s_{T}, and the action a_{T} that was performed by evaluating the metaheuristic algorithm in the state s_{T}. However, it should be noted that the states (s₀, s₁, s_{T}) and the actions (a₀, a₁ . . . a_{U}) as illustrated in FIG. 3 are for purposes only and are not limiting. Those skilled in the relevant art(s) will recognize that different states and/or actions are possible without departing from the present disclosure.

Once the possible solutions 302.1 through 302.N have been decomposed into the trajectories of placement data 304.1 through 304.N, the model training tool 300 estimates reward scores r₀ through r_{T} that can be expected for performing the actions (a₀, a₁ . . . a_{U}) over the states (s₀, s₁, . . . s_{T}). In some embodiments, the model training tool 116 can estimate the rewards based upon the final energies, or the final reward scores, for example, reward score R_{T} and/or reward score R_{T-N} as illustrated in FIG. 3, that were determined by evaluating the one or more energy functions ƒ(X̅) over final states from among the states (s₀, s₁, . . . s_{T}), for example, the state s_{T} and the state s_{T-N} as illustrated in FIG. 3. As illustrated in FIG. 3, the model training tool 300 can inspect the states (s₀, s₁, . . . s_{T}) and the actions (a₀, a₁ . . . a_{U}) that were performed in each of the states (s₀, s₁, . . . s_{T}) backwards starting from the final states. In these embodiments, the model training tool 300 can estimate the reward scores r₀ through r_{T-N-1} over the (s₀, s₁, . . . s_{T-N-1}) based on the final reward scores using, for example, a backtracking algorithm. For example, for the possible solution 302.1, the model training tool 300 can estimate the reward score r₃ that is to be expected by performing the action a₃ in the state s₂ based upon the reward score r_{T-N} and estimate the reward score r₂ that is to be expected by performing the action a₂ in the state s₁ based upon the reward score n.

After estimating the rewards, the model training tool 300 can estimate value functions V(0) through V(T) for the states (s₀, s₁, . . . s_{T}). As described above, the model training tool 300 can estimate the value function as being approximately equivalent to a sum of a product between the reward scores r₀ through r_{T} for the actions (a₀, a₁ . . . a_{U}) that were performed while in the states (s₀, s₁, . . . s_{T}) and the probabilities of selecting the actions (a₀, a₁ . . . a_{U}) while in the states (s₀, s₁, . . . s_{T}) as outlined by the policy function. For example, the value function for the state s₀, denoted as V(0), can be expressed as the sum of a first product of the reward score r₀ and a probability of perform action a₀ while in state s₀ as outlined by the policy function and a second product of the reward score r₁ and a probability of perform action a₁ while in state s₀ as outlined by the policy function.

Operations of the Electronic Design Platform

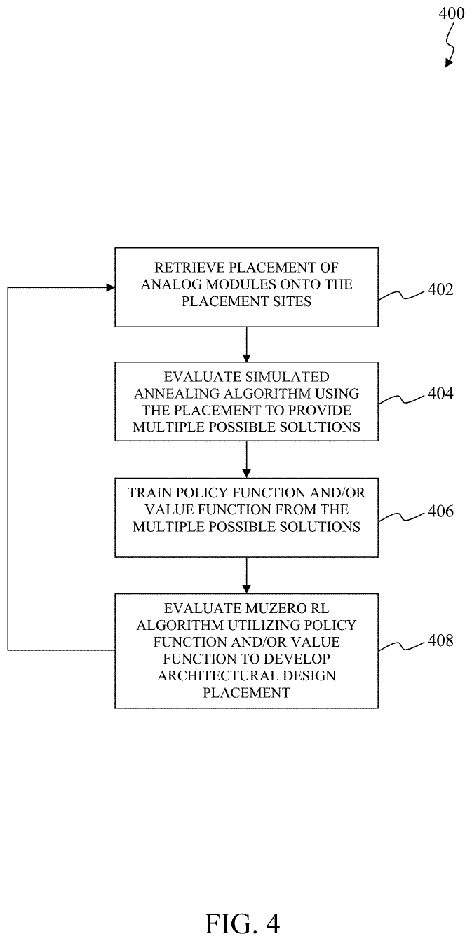

FIG. 4 illustrates a flowchart of an operation of the electronic design platform in placing analog modules onto placement sites. The disclosure is not limited to this operational description. Rather, it will be apparent to ordinary persons skilled in the relevant art(s) that other operational control flows are within the scope and spirit of the present disclosure. The following discussion describes an operational control flow 400 to logically place analog modules of an electronic device onto an electronic design real estate to determine an architectural design placement for the electronic circuitry. Generally, the analog modules can include one or more analog circuits and/or one or more combinations of the one or more analog circuits and one or more digital circuits, often referred to as one or more mixed-signal circuits. The one or more analog circuits operate on one or more analog signals that continuously vary in time. The one or more analog circuits can include one or more current sources, one or more current mirrors, one or more amplifiers, one or more bandgap references, and/or other suitable analog circuits that will be apparent to those skilled in the relevant art(s) without departing from the present disclosure. These analog modules can be implemented with as metal oxide silicon (MOS) transistors, resistors, inductors, capacitors, and/or other suitable analog components that will be apparent to those skilled in the relevant art(s) without departing from the present disclosure to provide some examples. The one or more digital circuits operate on one or more digital signals having one or more discrete levels. The one or more digital circuits can include one or more logic gates, such as logical AND gates, logical OR gates, logical XOR gates, logical XNOR gates, or logical NOT gates to provide some examples, and/or other suitable digital circuits that will be apparent to those skilled in the relevant art(s) without departing from the present disclosure. In the embodiment illustrated in FIG. 4, the analog modules can include the one or more analog circuits and/or the one or more mixed-signal circuits and their interconnect structures that functionally cooperate with one another to provide one or more functions of the electronic device. In some embodiments, the analog modules can occupy arbitrary rectangular shapes on the electronic design real estate in a substantially similar manner as the rectangular modules as described above in FIG. 1. The operational control flow 400 can represent an operation of the placing and routing tool 104 in logically placing the components of the electronic circuitry of the electronic device onto the electronic design real estate as described above in FIG. 1.

At operation 402, the operational control flow 400 retrieves a placement of the analog modules onto the electronic design real estate. The electronic design real estate can include a series of rows that intersect with a series of columns to form the placement sites for placing the analog modules onto the electronic design real estate. Generally, these placement sites represent basic units of integrated circuit design for placing the rectangular modules. As to be described in further detail below, a simulated annealing algorithm begins with the placement from operation 402 as being an initial placement of the analog modules onto the placement sites, also referred to as an initial solution. In some embodiments, the initial solution can be a random initial placement of the rectangular modules onto the placement sites and/or can be determined by a MuZero reinforcement learning (RL) algorithm as to be described in further detail below.

At operation 404, the operational control flow 400 evaluates the simulated annealing algorithm using the placement from operation 402 to provide multiple possible solutions for placing the analog modules onto the placement sites. The operational control flow 400 iteratively moves one or more analog modules from the placement in operation 402 in a substantially similar manner as described above in FIG. 1 to provide multiple placements of the analog modules onto the placement sites, also referred to as the multiple possible solutions.

At operation 406, the operational control flow 400 utilizes the multiple possible solutions from operation 404 to train a policy function and/or a value function of a MuZero reinforcement learning (RL) algorithm. The operational control flow 400 decomposes the multiple possible solutions from operation 404 into their states, actions, and/or reward scores to provide multiple trajectories of placement data in a substantially similar manner as described above in FIG. 1, FIG. 2, and FIG. 3. Once the multiple possible solutions from operation 404 have been decomposed into the multiple trajectories of placement data, the operational control flow 400 estimates probability density functions that outline probability distributions for performing the actions while in the states from the multiple possible solutions from operation 404 in a substantially similar manner as described above in FIG. 1 and FIG. 2 to estimate the policy function. Alternatively, or in addition to, the operational control flow 400 can estimate the value, or worth, of being in the states from the multiple possible solutions from operation 404 in a substantially similar manner as described above in FIG. 1 and FIG. 3 to estimate the value function.

At operation 408, the operational control flow 400 evaluates the MuZero RL algorithm utilizing the policy function and/or the value function from operation 406 to determine the architectural design placement. In the embodiment illustrated in FIG. 4, the operational control flow 400 can evaluate the MuZero RL algorithm using the Markov decision process (MDP) in a substantially similar manner as described above in FIG. 1. As part of the MDP, the operational control flow 400 can implement the general-purpose Monte Carlo tree search (MCTS) algorithm as described above in FIG. 1 to identify the best action a from among the set of actions A to be performed while in the specific state s in accordance with the policy function and/or the value function from operation 406. In some embodiments, the operational control flow 400 can provide the architectural design placement to operation 402 to be used as the initial solution which can be used to once again to evaluate the simulated annealing algorithm from operation 404. In these embodiments, the operational control flow 400 can further iteratively enhance the architectural design placement by re-evaluating the simulated annealing algorithm at operation 404 starting from the architectural design placement as the initial placement of components, re-training the policy function and/or the value function from operation 406, and re-evaluating the MuZero RL algorithm utilizing the policy function and/or the value function from operation 406 to enhance the architectural design placement.

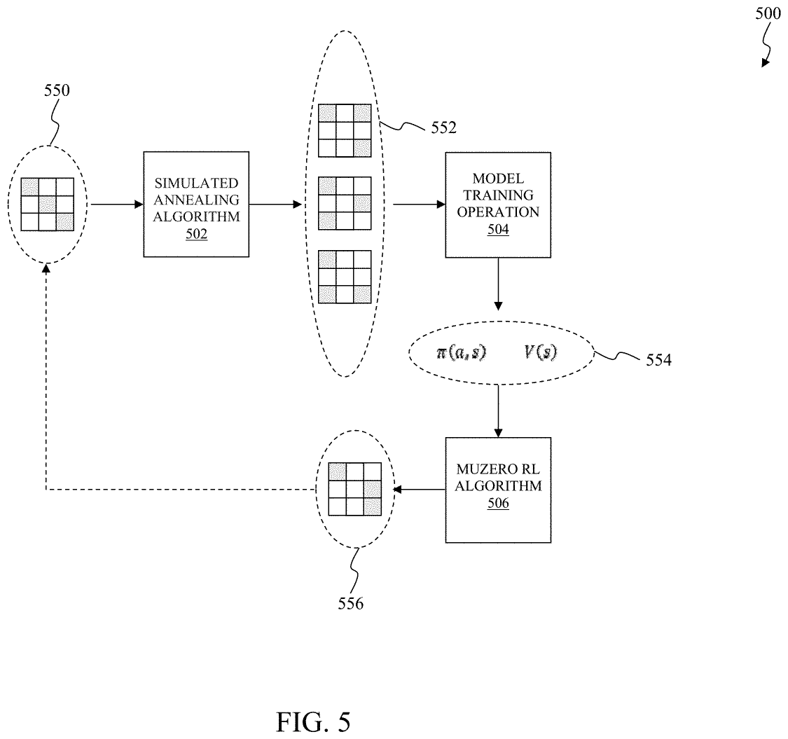

FIG. 5 graphically illustrates an operation of the electronic design platform in placing analog modules onto placement sites. The disclosure is not limited to this operational description. Rather, it will be apparent to ordinary persons skilled in the relevant art(s) that other operational control flows are within the scope and spirit of the present disclosure. The following discussion describes an operational control flow 500 to logically place analog modules of an electronic device onto an electronic design real estate to determine an architectural design placement for the electronic circuitry. Generally, the analog modules can include one or more analog circuits and/or the one or more combinations of the one or more analog circuits and the one or more digital circuits, often referred to as the one or more mixed-signal circuits, in a substantially similar manner as described above in FIG. 4. In the embodiment illustrated in FIG. 5, the analog modules can include the one or more analog circuits and/or the one or more mixed-signal circuits and their interconnect structures that functionally cooperate with one another to provide one or more functions of the electronic device. In some embodiments, the analog modules can occupy arbitrary rectangular shapes on the electronic design real estate in a substantially similar manner as the rectangular modules as described above in FIG. 1. The operational control flow 500 can represent an operation of the placing and routing tool 104 in logically placing the components of the electronic circuitry of the electronic device onto the electronic design real estate as described above in FIG. 1.

As illustrated in FIG. 5, one or more computer systems, an embodiment of which is to be described in further detail below, can evaluate a simulated annealing algorithm 502 to place the analog modules onto an electronic design real estate in a substantially similar manner as described above in FIG. 1. In the embodiment illustrated in FIG. 5, the one or more computer systems can move the components onto the placement sites from their placement in an existing placement, also referred to as an existing solution, to provide a new placement of the components onto the placement sites, also referred to as a new solution, in a substantially similar manner as described above in FIG. 1. In particular, the one or more computer systems can move the analog modules from their placement in an initial placement of the analog modules, also referred to as an initial solution 550, to provide a possible placement of the analog modules onto the placement sites, also referred to as a possible solution from among many possible solutions 552, in a substantially similar manner as described above in FIG. 1. The one or more computer systems can evaluate the simulated annealing algorithm 502 over multiple iterations to provide the remainder of the possible solutions from among the possible solutions 552 starting from the initial solution 550 in a substantially similar manner as described above in FIG. 1.

After evaluating the simulated annealing algorithm 502, the one or more computer systems can perform a model training operation 504 to train a policy function π(a, s) and/or a value function V(s) of a MuZero reinforcement learning (RL) algorithm 506. The one or more computer systems decomposes the possible solutions 552 into their states, actions, and/or reward scores to provide multiple trajectories of placement data as described above in FIG. 1, FIG. 2, and FIG. 3. Once the multiple possible solutions from operation 404 have been decomposed into the multiple trajectories of placement data, the one or more computer systems estimates probability density functions that outline probability distributions for performing the actions while in the states from the one or more computer systems as described above in FIG. 1 and FIG. 2 to estimate the policy function π(a, s). Alternatively, or in addition to, the operational control flow 400 can estimate the value, or worth, of being in the states from the possible solutions 552 as described above in FIG. 1 and FIG. 3 to estimate the value function V (s).

After training the policy function π(a, s) and/or the value function V(s), the one or more computer systems evaluate the MuZero RL algorithm utilizing the policy function π(a, s) and/or the value function V(s) to determine an architectural design placement 556. In the embodiment illustrated in FIG. 5, the one or more computer systems can evaluate the MuZero RL algorithm using the Markov decision process (MDP) in a substantially similar manner as described above in FIG. 1. As part of the MDP, the one or more computer systems can implement the general-purpose Monte Carlo tree search (MCTS) algorithm as described above in FIG. 1 to identify the best action a from among the set of actions A to be performed while in the specific state s in accordance with the policy function π(a, s) and/or the value function V(s). In some embodiments, the one or more computer systems can provide the architectural design placement 556 to be used as the initial solution 550 for the simulated annealing algorithm 502. In these embodiments, the one or more computer systems can further iteratively enhance the architectural design placement by re-evaluating the simulated annealing algorithm starting from the architectural design placement as the initial placement of components, re-training the policy function π(a, s) and/or the v value function V(s), and re-evaluating the MuZero RL algorithm utilizing the policy function π(a, s) and/or the value function V(s) to enhance the architectural design placement.

Computer Network for Executing the Design Environment

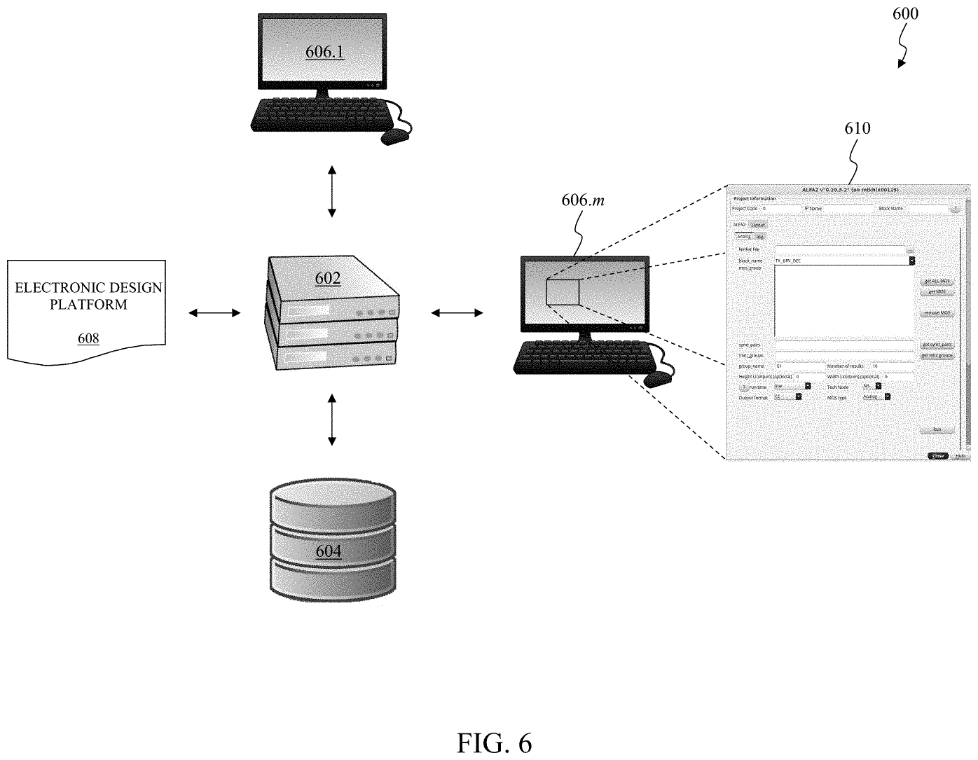

FIG. 6 graphically illustrates a simplified block diagram of a computer network for executing the electronic design platform according to some embodiments of the present disclosure. As described above, the one or more electronic design software tools can be executed by one or more computing devices, processors, controllers, or other electrical, mechanical, and/or electro-mechanical devices to design, simulate, analyze, and/or verify architectural design layout of electronic circuitry for an electronic device. The discussion of FIG. 6 to follow is to describe a computer network 600 that can be used to execute the one or more electronic design software tools, such as the synthesis tool 102, the placing and routing tool 104, the simulation tool 106, and/or the verification tool 108 as described above in FIG. 1. The computer network 600 can represent an embodiment of these one or more computing devices, processors, controllers, or other electrical, mechanical, and/or electro-mechanical devices.

As illustrated in FIG. 6, the computer network 600 can include an electronic design server platform 602, an electronic design memory storage system 604, and electronic design workstations 606.1 through 606.m. Although the computer network 600 is illustrated in FIG. 6 as including multiple, distinct devices, those skilled in the relevant art(s) will recognize that one of more of the devices can be combined together without departing from the present disclosure.

The electronic device server platform 602 represents one or more computer systems, an embodiment of which is to be described in further detail below, which facilitate determining an architectural design layout of electronic circuitry for an electronic device. In some embodiments, the electronic device server platform 602 can include one or more processors to execute an electronic design platform 608 to determine the architectural design layout. In some embodiments, the electronic design platform 608 represents an electronic design flow including one or more electronic design software tools, that when executed by the one or more processors can design, simulate, analyze, and/or verify the architectural design layout. In these embodiments, the electronic design platform 608 can represent an embodiment of the electronic design platform 100 as described above. As such, the electronic design platform 608 can include the synthesis tool 102, the placing and routing tool 104, the simulation tool 106, the verification tool 108, and/or any combination thereof as described above in FIG. 1. Alternatively, or in addition to, the electronic device server platform 602 can include a machine-readable medium that stores the electronic design platform 608. In some embodiments, the one or more processors can execute the electronic design platform 608 that is stored in the machine-readable medium to determine the architectural design layout.

The electronic design memory storage system 604 can store data and information that is utilized by the electronic device server platform 602 to execute the electronic design platform 608. In some embodiments, the electronic design memory storage system 604 can include one or more machine-readable mediums to store the architectural design placement, the architectural design layout, and/or portions thereof that are determined by the electronic design platform 608 in a substantially similar manner as described above in FIG. 1. Alternatively, or in addition to, these machine-readable mediums can store any of the data and information that is utilized by the electronic device server platform 602 to determine the architectural design placement and/or the architectural design layout that will be apparent to those skilled in the relevant art(s) without departing from the present disclosure. This data and information can include the states, actions, and/or reward scores utilized by the metaheuristic algorithm and/or the model-based reinforcement learning (RL) algorithm as described above in FIG. 1 through FIG. 5 to provide an example.

The electronic design workstations 606.1 through 606.m interface with the electronic device server platform 602 and/or the electronic design memory storage system 604 to execute the electronic design platform 608. In the embodiment illustrated in FIG. 6, the electronic design workstations 606.1 through 606.m can execute software that displays a graphical user interface (GUI) 610 to interface with the electronic design platform 608. In the embodiment illustrated in FIG. 6, the GUI 610 can include various buttons, sliders, list boxes, spinners, drop-down lists, menus, menu bars, toolbars, combo boxes, icons, container windows, browser windows, child windows, and/or message windows for providing data and information between the electronic device server platform 602 and the electronic device server platform 602. In some embodiments, this data and information can include input data and information that is utilized by the electronic device server platform 602 to execute the electronic design platform 608 and/or output data and information that is determined by the electronic device server platform 602 while executing the electronic design platform 608.

Computer System for Executing the Design Environment

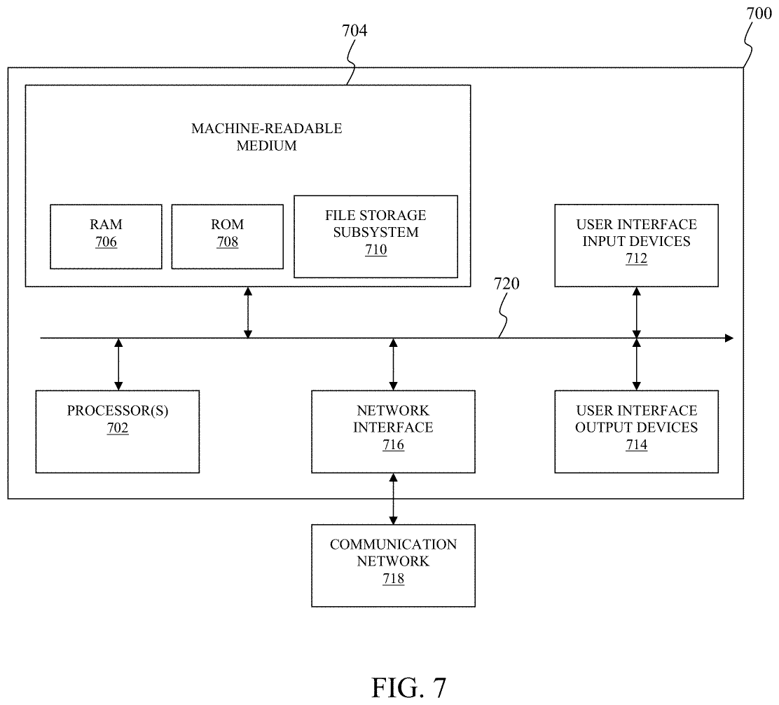

FIG. 7 graphically illustrates a simplified block diagram of a computer system for executing the electronic design platform according to some embodiments of the present disclosure. As described above, one or more electronic design software tools can be executed by one or more computing devices, processors, controllers, or other electrical, mechanical, and/or electro-mechanical devices that will be apparent to those skilled in the relevant art(s) without departing from the spirit and the scope of the present disclosure, to design, simulate, analyze, and/or verify architectural design layout of electronic circuitry for an electronic device. The discussion of FIG. 7 to follow is to describe a computer system 700 that can be used to execute the one or more electronic design software tools, such as the synthesis tool 102, the placing and routing tool 104, the simulation tool 106, and/or the verification tool 108 as described above in FIG. 1. The computer system 700 can represent an embodiment of these one or more computing devices, processors, controllers, or other electrical, mechanical, and/or electro-mechanical devices.

In the embodiment illustrated in FIG. 7, the computer system 700 includes one or more processors 702 to execute the one or more electronic design software tools as described above in FIG. 1. In some embodiments, the one or more processors 702 can include, or can be, any of a microprocessor, graphics processing unit, or digital signal processor, and their electronic processing equivalents, such as an Application Specific Integrated Circuit (“ASIC”) or Field Programmable Gate Array (“FPGA”). As used herein, the term “processor” signifies a tangible data and information processing device that physically transforms data and information, typically using a sequence transformation (also referred to as “operations”). Data and information can be physically represented by an electrical, magnetic, optical or acoustical signal that is capable of being stored, accessed, transferred, combined, compared, or otherwise manipulated by the processor. The term “processor” can signify a singular processor and multi-core systems or multi-processor arrays, including graphic processing units, digital signal processors, digital processors or combinations of these elements. The processor can be electronic, for example, comprising digital logic circuitry (for example, binary logic), or analog (for example, an operational amplifier). The processor may also operate to support performance of the relevant operations in a “cloud computing” environment or as a “software as a service” (SaaS). For example, at least some of the operations may be performed by a group of processors available at a distributed or remote system, these processors accessible via a communications network (e.g., the Internet) and via one or more software interfaces (e.g., an application program interface (API).) In some embodiments, the computer system 700 can include an operating system, such as Microsoft's Windows, Sun Microsystems's Solaris, Apple Computer's MacOs, Linux or UNIX. In some embodiments, the computer system 700 can also include a Basic Input/Output System (BIOS) and processor firmware. The operating system, BIOS and firmware are used by the one or more processors 702 to control subsystems and interfaces coupled to the one or more processors 702. In some embodiments, the one or more processors 702 can include the Pentium and Itanium from Intel, the Opteron and Athlon from Advanced Micro Devices, and the ARM processor from ARM Holdings.

As illustrated in FIG. 7, the computer system 700 can include a machine-readable medium 704. In some embodiments, the machine-readable medium 704 can further include a main random-access memory (“RAM”) 706, a read only memory (“ROM”) 708, and/or a file storage subsystem 710. The RAM 730 can store instructions and data during program execution and the ROM 732 can store fixed instructions. The file storage subsystem 710 provides persistent storage for program and data files, and may include a hard disk drive, a floppy disk drive along with associated removable media, a CD-ROM drive, an optical drive, a flash memory, or removable media cartridges.

The computer system 700 can further include user interface input devices 712 and user interface output devices 714. The user interface input devices 712 can include an alphanumeric keyboard, a keypad, pointing devices such as a mouse, trackball, touchpad, stylus, or graphics tablet, a scanner, a touchscreen incorporated into the display, audio input devices such as voice recognition systems or microphones, eye-gaze recognition, brainwave pattern recognition, and other types of input devices to provide some examples. The user interface input devices 712 can be connected by wire or wirelessly to the computer system 700. Generally, the user interface input devices 712 are intended to include all possible types of devices and ways to input information into the computer system 700. The user interface input devices 712 typically allow a user to identify objects, icons, text and the like that appear on some types of user interface output devices, for example, a display subsystem. The user interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other device for creating a visible image such as a virtual reality system. The display subsystem may also provide non-visual display such as via audio output or tactile output (e.g., vibrations) devices. Generally, the user interface output devices 720 are intended to include all possible types of devices and ways to output information from the computer system 700.

The computer system 700 can further include a network interface 716 to provide an interface to outside networks, including an interface to a communication network 718, and is coupled via the communication network 718 to corresponding interface devices in other computer systems or machines. The communication network 718 may comprise many interconnected computer systems, machines and communication links. These communication links may be wired links, optical links, wireless links, or any other devices for communication of information. The communication network 718 can be any suitable computer network, for example a wide area network such as the Internet, and/or a local area network such as Ethernet. The communication network 718 can be wired and/or wireless, and the communication network can use encryption and decryption methods, such as is available with a virtual private network. The communication network uses one or more communications interfaces, which can receive data from, and transmit data to, other systems. Embodiments of communications interfaces typically include an Ethernet card, a modem (e.g., telephone, satellite, cable, or ISDN), (asynchronous) digital subscriber line (DSL) unit, Firewire interface, USB interface, and the like. One or more communications protocols can be used, such as HTTP, TCP/IP, RTP/RTSP, IPX and/or UDP.

As illustrated in FIG. 7, the one or more processors 702, the machine-readable medium 704, the user interface input devices 712, the user interface output devices 714, and/or the network interface 716 can be communicatively coupled to one another using a bus subsystem 720. Although the bus subsystem 720 is shown schematically as a single bus, alternative embodiments of the bus subsystem may use multiple busses. For example, RAM-based main memory can communicate directly with file storage systems using Direct Memory Access (“DMA”) systems.

### CONCLUSION

The Detailed Description referred to accompanying figures to illustrate embodiments consistent with the disclosure. References in the disclosure to “an embodiment” indicates that the embodiment described can include a particular feature, structure, or characteristic, but every embodiment may not necessarily include the particular feature, structure, or characteristic. Moreover, such phrases are not necessarily referring to the same embodiment. Further, any feature, structure, or characteristic described in connection with an embodiment can be included, independently or in any combination, with features, structures, or characteristics of other embodiments whether or not explicitly described.

The Detailed Description is not meant to limiting. Rather, the scope of the disclosure is defined only in accordance with the following claims and their equivalents. It is to be appreciated that the Detailed Description section, and not the Abstract section, is intended to be used to interpret the claims. The Abstract section can set forth one or more, but not all embodiments, of the disclosure, and thus, are not intended to limit the disclosure and the following claims and their equivalents in any way.

The embodiments described within the disclosure have been provided for illustrative purposes and are not intended to be limiting. Other embodiments are possible, and modifications can be made to the embodiments while remaining within the spirit and scope of the disclosure. The disclosure has been described with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

Embodiments of the disclosure can be implemented in hardware, firmware, software application, or any combination thereof. Embodiments of the disclosure can also be implemented as instructions stored on a machine-readable medium, which can be read and executed by one or more processors. A machine-readable medium can include any mechanism for storing or transmitting information in a form readable by a machine (e.g., a computing circuitry). For example, a machine-readable medium can include non-transitory machine-readable mediums such as read only memory (ROM); random access memory (RAM); magnetic disk storage media; optical storage media; flash memory devices; and others. As another example, the machine-readable medium can include transitory machine-readable medium such as electrical, optical, acoustical, or other forms of propagated signals (e.g., carrier waves, infrared signals, digital signals, etc.). Further, firmware, software application, routines, instructions can be described herein as performing certain actions. However, it should be appreciated that such descriptions are merely for convenience and that such actions in fact result from computing devices, processors, controllers, or other devices executing the firmware, software application, routines, instructions, etc.

The Detailed Description of the embodiments fully revealed the general nature of the disclosure that others can, by applying knowledge of those skilled in relevant art(s), readily modify and/or adapt for various applications such embodiments, without undue experimentation, without departing from the spirit and scope of the disclosure. Therefore, such adaptations and modifications are intended to be within the meaning and plurality of equivalents of the embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

What is claimed is:

1. A computer system for placing electronic circuitry of an electronic device onto an electronic design real estate, the computer system comprising:
a memory that stores a plurality of electronic design software tools; and
a processor configured to execute the plurality of electronic design software tools, the electronic design software tools, when executed by the processor, configuring the processor to:
evaluate a metaheuristic algorithm to provide a plurality of possible solutions for placing the electronic circuitry onto the electronic design real estate from an initial placement of the electronic circuitry onto the electronic design real estate,
utilize the plurality of possible solutions to train one or more probabilistic functions of a model-based reinforcement learning (RL) algorithm,
evaluate the model-based RL algorithm utilizing the one or more probabilistic functions to place the electronic circuitry onto the electronic design real estate to determine the architectural design placement.

2. The computer system of claim 1, wherein the electronic design software tools, when executed by the processor, further configure the processor to:
provide the architectural design placement to the metaheuristic algorithm;
evaluate the metaheuristic algorithm to provide a second plurality of possible solutions for placing the electronic circuitry onto the electronic design real estate from the architectural design placement;
utilize the second plurality of possible solutions to train the one or more probabilistic functions; and
evaluate the model-based RL algorithm utilizing the one or more probabilistic functions to place the electronic circuitry onto the electronic design real estate to determine a second architectural design placement.

3. The computer system of claim 1, wherein the metaheuristic algorithm comprises a simulated annealing algorithm, and
wherein the model-based RL algorithm comprises a MuZero RL algorithm.

4. The computer system of claim 1, wherein the electronic design software tools, when executed by the processor, configure the processor to decompose the plurality of possible solutions into a plurality of states and a plurality of actions that were performed by the metaheuristic algorithm to determine the plurality of possible solutions to provide a plurality of trajectories of placement data.

5. The computer system of claim 4, wherein the electronic design software tools, when executed by the processor, configure the processor to estimate a plurality of probability distributions for performing the plurality of actions over the plurality of states to determine a policy function from among the one or more probabilistic functions.

6. The computer system of claim 4, wherein the electronic design software tools, when executed by the processor, configure the processor to:
further decompose the plurality of possible solutions into a plurality of final reward scores that are associated with the plurality of trajectories of placement data; and
estimate a plurality of rewards to be expected for performing the plurality of actions over the plurality of states using a backtracking algorithm starting from the plurality of final reward scores.

7. The computer system of claim 5, wherein the electronic design software tools, when executed by the processor, configure the processor to estimate a value function from among the one or more probabilistic functions as being approximately equivalent to a sum of a plurality of products of the plurality of rewards for the plurality of actions that were performed while in the plurality of states and the probabilities of selecting the plurality of actions while in the plurality of states.

8. A method for placing a plurality of analog modules of an electronic device onto an electronic design real estate, the method comprising:
evaluating, by a computer system, a simulated annealing algorithm to provide a plurality of possible solutions for placing the plurality of analog modules onto a plurality of placement sites of the electronic design real estate from an initial placement of the plurality of analog modules onto the plurality of placement sites;
utilizing, by the computer system, the plurality of possible solutions to train a policy function and a value function of a MuZero reinforcement learning (RL) algorithm;
evaluating, by the computer system, the MuZero RL algorithm utilizing the policy function and the value function to place the plurality of analog modules onto the plurality of placement sites to determine the architectural design placement; and
iteratively enhancing, by the computer system, the architectural design placement by re-evaluating the simulated annealing algorithm starting from the architectural design placement as the initial placement of components, re-training the policy function and the value function, and re-evaluating the MuZero RL algorithm utilizing the policy function and the value function.

9. The method of claim 8, wherein the plurality of analog modules comprises a plurality of analog circuits and their interconnect structures that functionally cooperate with one another to provide a plurality of functions of the electronic device.

10. The method of claim 8, further comprising:
logically intersecting, by the computer system, a series of rows within the electronic design real estate and a plurality of columns within the electronic design real estate to form the plurality of placement sites for placing the plurality of analog modules.

11. The method of claim 8, wherein the utilizing comprises decomposing the plurality of possible solutions into a plurality of states and a plurality of actions that were performed by the simulated annealing algorithm to determine the plurality of possible solutions to provide a plurality of trajectories of placement data.

12. The method of claim 11, wherein the utilizing further comprises estimating a plurality of probability distributions for performing the plurality of actions over the plurality of states to determine the policy function.

13. The method of claim 11, wherein the utilizing further comprises:
further decomposing the plurality of possible solutions into a plurality of final reward scores that are associated with the plurality of trajectories of placement data; and
estimating a plurality of rewards to be expected for performing the plurality of actions over the plurality of states using a backtracking algorithm starting from the plurality of final reward scores.

14. The method of claim 13, wherein the utilizing further comprises estimating a value function from among the one or more probabilistic functions as being approximately equivalent to a sum of a plurality of products of the plurality of rewards for the plurality of actions that were performed while in the plurality of states and the probabilities of selecting the plurality of actions while in the plurality of states.

15. A computer network for placing electronic circuitry of an electronic device onto an electronic design real estate, the computer network comprising:
an electronic design server platform configured to execute a plurality of electronic design software tools, the electronic design software tools, when executed by the electronic design server platform, configuring the electronic design server platform to:
evaluate a metaheuristic algorithm to provide a plurality of possible solutions for placing the electronic circuitry onto a plurality of placement sites of the electronic design real estate from an initial placement of the electronic circuitry onto the plurality of placement sites,
utilize the plurality of possible solutions to train a policy function and a value function of a model-based reinforcement learning (RL) algorithm,
evaluate the model-based RL algorithm utilizing the policy function and the value function to place the electronic circuitry onto the plurality of placement sites to determine the architectural design placement, and
iteratively enhance the architectural design placement by re-evaluating the metaheuristic algorithm starting from the architectural design placement as the initial placement of components, re-training the policy function and the value function, and re-evaluating the model-based RL algorithm utilizing the policy function and the value function; and
an electronic design workstation configured to interface with the electronic device server platform to execute the electronic design platform.

16. The computer network of claim 15, wherein the electronic design workstation is configured to execute a graphical user interface (GUI) to interface with the electronic design platform, and
wherein the GUI, when executed by the electronic design workstation, configures the electronic design workstation to send input data and information to the electronic design server platform that is to be utilized by the electronic design server platform to execute the electronic design platform or receive output data and information from the electronic design server platform that is determined by the electronic device server platform while executing the electronic design platform.

17. The computer network of claim 15, wherein the electronic design software tools, when executed by the electronic design server platform, further configure the electronic design server platform to logically intersect a series of rows within the electronic design real estate and a plurality of columns within the electronic design real estate to form the plurality of placement sites for placing the plurality of analog modules.

18. The computer network of claim 15, wherein the electronic design software tools, when executed by the electronic design server platform, configure the electronic design server platform to decompose the plurality of possible solutions into a plurality of states and a plurality of actions that were performed by the simulated annealing algorithm to determine the plurality of possible solutions to provide a plurality of trajectories of placement data.

19. The computer network of claim 15, wherein the electronic design software tools, when executed by the electronic design server platform, configure the electronic design server platform to estimate a plurality of probability distributions for performing the plurality of actions over the plurality of states to determine the policy function.

20. The computer network of claim 15, wherein the electronic design software tools, when executed by the electronic design server platform, configure the electronic design server platform to:
further decompose the plurality of possible solutions into a plurality of final reward scores that are associated with the plurality of trajectories of placement data; and
estimate a plurality of rewards to be expected for performing the plurality of actions over the plurality of states using a backtracking algorithm starting from the plurality of final reward scores.

21. The computer network of claim 20, wherein the electronic design software tools, when executed by the electronic design server platform, configure the electronic design server platform to estimate a value function from among the one or more probabilistic functions as being approximately equivalent to a sum of a plurality of products of the plurality of rewards for the plurality of actions that were performed while in the plurality of states and the probabilities of selecting the plurality of actions while in the plurality of states.
